(19) United States
(12) Patent Application Publication
(10) Pub. No.: US 2008/0288996 A1
(43) Pub. Date: Nov. 20, 2008

(54) METHOD AND APPARATUS FOR PROVISIONING MEDIA CONTENT IN A MULTI-USER ENVIRONMENT

(75) Inventors: EDWARD WALTER, BOERNE, TX (US); LARRY B. PEARSON, SAN ANTONIO, TX (US); JERALD R. HOWCROFT, BEVERLY HILLS, MI (US)

Correspondence Address: AKERMAN SENTERFITT, P.O. BOX 3188, WEST PALM BEACH, FL, 33402-3188, US

(73) Assignee: AT&T KNOWLEDGE VENTURES, LP, RENO, NV (US)

(21) Appl. No.: 11/749,030

(22) Filed: May 15, 2007

(51) Int. Cl. H04N 7/16

(52) U.S. Cl. 725/131

(57) ABSTRACT

A method and apparatus for provisioning media content in a multi-user environment is disclosed. A system that incorporates teachings of the present disclosure may include, for example, a Set-Top Box having a controller element to: receive multimedia content from a communication system; configure individual access to the multimedia content among a group of users in accordance with individual user profiles, wherein each of the individual user profiles has a separate service package provided by one or more broadband providers; and provision a delivery of the multimedia content to a media device in accordance with access settings defined at least in part in the individual user profiles. Additional embodiments are disclosed.

### FIELD OF THE DISCLOSURE

The present disclosure relates generally to provisioning techniques in communication systems and more specifically to a method and apparatus for provisioning media content in a multi-user environment.

### BACKGROUND

Deployment of Set-Top Boxes (STBs) in residences and commercial enterprises enables presentation of media services on one or more media devices such as a plasma TV or a desktop computer. Although STBs allow for various types of content to be delivered to the residences and commercial enterprises, the entirety of the content is directed to the household or enterprise. In a multi-user setting in which an STB is shared by multiple parties, it may not always be desirable to share content and/or services equally.

A need therefore arises for a method for provisioning a set-top box for use in a multi-user environment.

### BRIEF DESCRIPTION OF THE DRAWINGS

FIG. 1 depicts an exemplary embodiment of a communication system;

FIG. 2 depicts an exemplary method operating in the communication system;

FIG. 3 depicts a multi-user environment of a set-top box (STB);

FIGS. 4-10 depict exemplary embodiments for provisioning the STB;

FIG. 11 depicts an exemplary method for managing a delivery of media content in the multi-user environment of the STB;

FIG. 12 depicts an exemplary method for email messaging in the multi-user environment of the STB;

FIG. 13 depicts an exemplary method for voicemail messaging in the multi-user environment of the STB; and

FIG. 14 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for provisioning media content in a multi-user environment.

In a first embodiment of the present disclosure, a computer-readable storage medium in a Set-Top Box (STB), can have computer instructions for receiving multimedia content from one or more broadband providers; configuring individual access to the multimedia content among a group of users based on access settings of individual user accounts, wherein each of the individual user accounts has a separate service package provided by the one or more broadband providers, and wherein the access settings are managed by a primary member of the group; and provisioning the multimedia content in accordance with the access settings.

In a second embodiment of the present disclosure, a Set-Top Box (STB) can have a controller element to receive multimedia content from a communication system; configure individual access to the multimedia content among a group of users in accordance with individual user profiles, wherein each of the individual user profiles has a separate service package provided by one or more broadband providers; and provision a delivery of the multimedia content to a media device in accordance with access settings defined at least in part in the individual user profiles.

In a third embodiment of the present disclosure, a media device can have a controller element to receive media content from a Set-Top Box (STB), wherein access to the media content is provisioned for individual users in accordance with individual user account profiles managed by a primary member, and wherein the individual user account profiles have separate service packages provided by one or more broadband providers.

In a fourth embodiment of the present disclosure, a method can involve provisioning a distribution of media content to a plurality of users sharing a set-top-box (STB) in accordance with access settings in user profiles managed by a primary member, wherein the user profiles have a separate service package provided by one or more broadband providers.

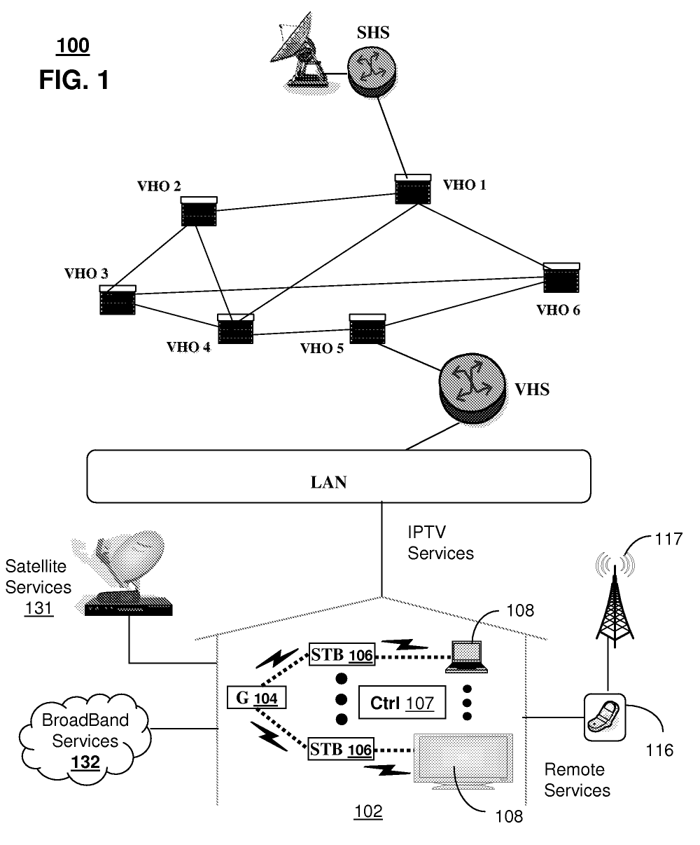

FIG. 1 depicts an exemplary embodiment of a communication system 100. The communication system 100 can comprise a number of common network elements interconnected by wired and/or wireless interfaces that support packet-switched and/or circuit-switched technologies. In one arrangement, the communication system 100 can comprise a multimedia system such as an internet Protocol Television (IPTV) system that can be configured to provide IPTV services. In a typical IPTV backbone, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to a property 102, such as commercial and/or residential buildings or other locations, housing a gateway 104 (e.g., a residential gateway or RG) that distributes broadcast signals to receivers such as a Set-Top Box (STB) 106 which in turn presents broadcast selections on display units or media devices 108 such as computers or television units managed in some instances by a media controller 107 (e.g., an infrared or RF remote control). Unicast traffic can also be exchanged between the STBs 106 and the subsystems of the IPTV communication system for presenting iTV services.

The IPTV system can also be combined with analog and digital broadcast distributions systems such as the Satellite Services 131 and/or the Broadband Services 132. The broadcast distribution systems can provide to the property 102, broadband media services to consumers by way of a broadband connection (e.g., PSTN, cable, xDSL, dial-up, Ethernet, satellite). Broadband media services can include without limitation voice, moving images (e.g., MPEG4, high definition, standard or streaming video), still images (e.g., JPEGs), audio entertainment (e.g., MP3, or streaming audio), or any form of data services. It should be noted that in the present context, media services can mean audio media, CD quality audio, TV programming, game videos, album management of still pictures, and so on.

The communication system 100 can also comprise a telecommunication system 117 that provides wireless access (e.g., CDMA, GSM, Software Defined Radio, Ultra Wide Band, WiMax, etc.) to one or more communication devices 116 (e.g. cell phone, portable music player, etc.) associated with the property 102. The telecommunication system 117 can support voice and data services such as GSM-GPRS, EDGE, CDMA-1X, UMTS, and other known technologies. The communication devices 116 can represent any number of embodiments including without limitation a laptop or desktop computer, a POTS phone, a personal digital assistance (PDA), a cellular phone, or paging device, just to name a few. Some or all of these devices can interface to the property 102 with a wired and/or wireless interface.

For example, the laptop can be interconnected with the property 102 by a wired Ethernet port to a DSL (Digital Service Line) interface in a residence or enterprise, and/or by a WiFi or WiMAX wireless connection. The POTS phone can utilize cordless 2.4 GHz or 5.8 GHz technology for short-range roaming, and interface to a communications network using POTS or VoIP communications. The PDA and cellular phone can support common wireless access technologies for interfacing to the property 102. As an example, a communication device 116 can communicate with the STB 106 to deliver media, such as voice, email, or any other voice and data services.

The STB 106 can be provided by a broadcast communications provider such as a cable, a satellite, or IPTV service provider to deliver a presentation of a media program at the media device 108. The STB 106 can receive telephony signals from a circuit-switched (e.g., PSTN) or packet-switched (e.g., VoIP) communication provider and manage the telephony signals and multimedia signals. Broadband signals received by the STB 106 can comprise at least one among digital and analog signals, each transporting at least one among image, audio data, or combinations thereof. The media program can be a television show, a paid subscription channel, or any other form of media broadcast.

The media controller 107 can be programmed to control the STB 106 and/or the media device 108. The media controller 107 can utilize common infrared or RF signaling technology to communicate with any of the aforementioned subsystems of the communication system 100, including services offered by the satellite system 131 and the broadband system 132. The media controller 107 can also include a user interface (UI) for controlling the STB 106 and a display for visually presenting media information.

The communication system 100 can comprise in whole or in part any of the aforementioned IPTV subsystems, cable TV subsystems, and/or satellite TV subsystems. Said subsystems can be centralized or decentralized computing devices operating within communication system 100.

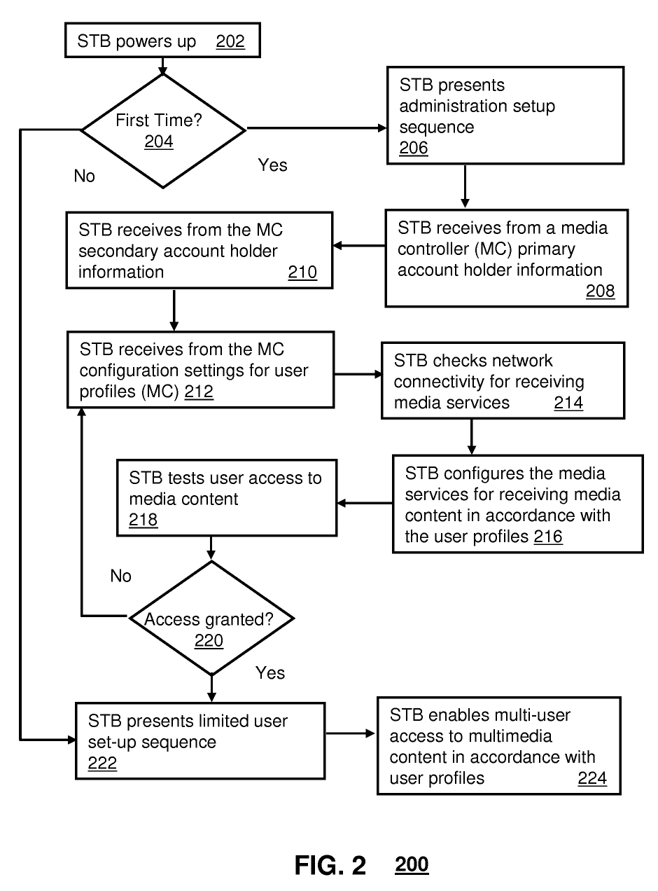

FIG. 2 depicts an exemplary method 200 operating in portions of the communication system 100. More specifically, method 200 can provide for setting up multiple user profiles in a multi-user environment to allow users to share media resources and access media content, such as at a single residence.

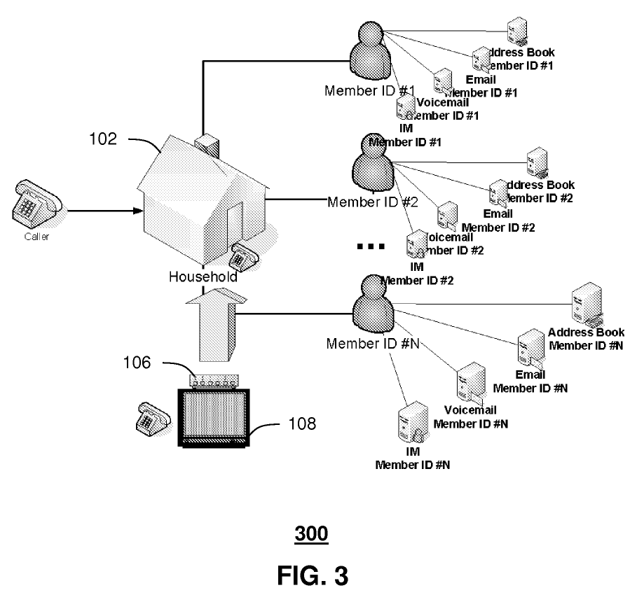

Method 200 begins with step 202 in which the STB 106 can power up and can determine in step 204 whether it is powering up for the first time. If it is not a first-time power up cycle, the STB 106 proceeds to step 222 where it can resume operations according to a user profile assigned to each user having access to the STB 106 in a multi-user environment, as shown for example in FIG. 3. If it is a first-time power up cycle, the STB 106 proceeds to step 206 where it can present to an administrator a setup sequence. The present disclosure also contemplates other configurations for the multi-user environment, including multiple locations such as in a dormitory.

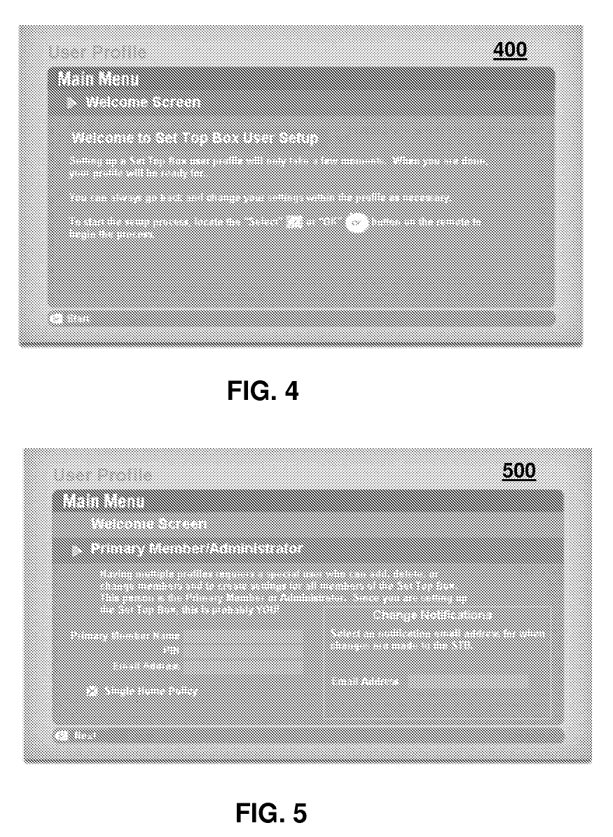

Referring additionally to FIGS. 4-9, a Graphical User Interface (GUI) of the display 108 is depicted that illustrates by way of example the initial steps of a first-time provisioning process. The present disclosure contemplates the use of other graphical user interfaces to facilitate the provisioning process. For example, in FIG. 4 the GUI 400 can present a welcome screen and an initial preview of what needs to be done to configure the STB 106 for multi-user profiles.

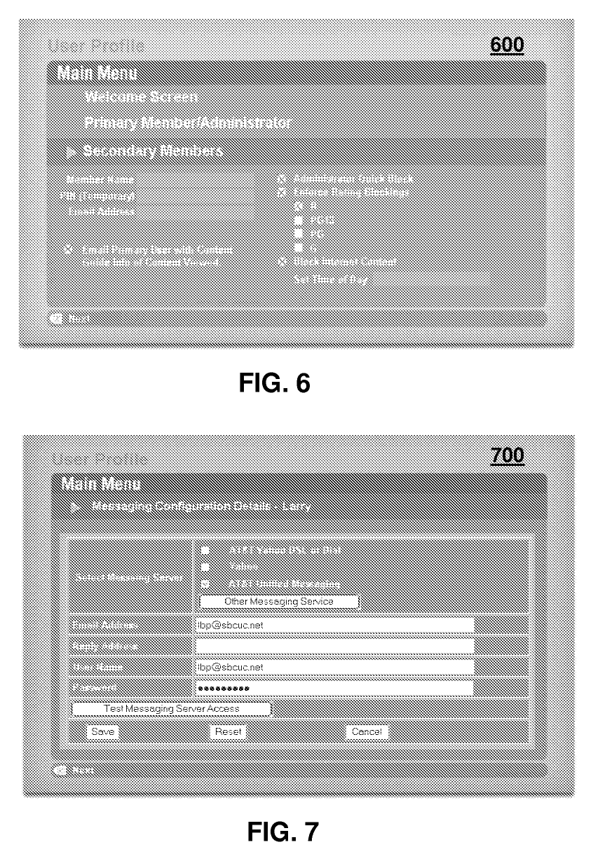

In steps 208-210, the STB 106 can request an identification of a primary member, which in the present context can be an administrator of the STB 106, and an identification of one or more secondary members, which can represent limited users of the STB 106. An administrator can have full privileges to manage the operation of the STB 106 on a per user basis, while limited users can have control and management over their own user profiles to the extent allowed by the administrator. The identification of a primary member and secondary member(s) is illustrated in GUIs 500 and 600 of FIGS. 5-6, respectively.

In step 212, the administrator can begin the process of provisioning the user profiles for each shared user of the STB 106 by applying one or more configuration settings. The configuration settings for the usage profile can be selected from a group of features supported by the STB 106 and at least one service provider of a communication network from which the STB 106 operates. The administrator, such as by way of the media controller 107, can input the configuration settings which are received by the STB 106 for setting up individual user accounts. In this step, the administrator can configure each user account with rights and permissions for accessing the multimedia content. In such regard, the administrator can individually limit or individually restrict a user's access to media content delivered to media devices 108. The administrator can also delegate to each user, through their respective user profile, access to the configuration settings. This allows each user to customize their own user profile with user preferences in accordance with the limits established by the administrator.

In one embodiment, the individual user accounts are separate services or service packages being provided by the broadband service providers. The distinct service packages can be tailored for each of the users of the group of users, including being tailored by the administrator or primary user of the group. The group of users can be separately billed for their respective service package that is associated with each of the individual user accounts.

As one example, shown in GUI 600 of FIG. 6, the administrator can establish parental controls in the user profiles such as those which limit viewing of certain programs, or impose other blocks such as by channel (e.g., DISNEY, CNN, NBC), time (e.g., 8 AM to 7 PM), content (e.g., action, drama, comedy), or rating (e.g., G, PG, R). The limited user can further customize the user profile for personal access to the multimedia content, for example, by arranging movies or news groups in order of favorites, adjusting audio settings, or modifying friends lists, to name a few. The administrator can also elect to receive email messages associated with any changes made to the user profile, for example, those made after the administrator has configured the user profiles. The administrator can also apply the configuration settings of a user profile to other devices in the property 102 (e.g., laptop, computer, other set-top boxes, etc.). In such regard, the user, regardless of which device is used to access media content, can have the same access to media content as provisioned in the user profile.

To ensure the STB 106 can apply the configuration settings to the user profiles, the STB 106 at step 214 can check network connectivity for the media services (e.g. Internet, email, voice mail, etc.). For example, the STB 106 can validate a type of broadband connectivity (e.g., POTS, DSL, cable, satellite, IPTV, dial-up) available to the property 102. Upon validating the type of broadband connectivity that is available, the STB 106 as shown in step 216 can configure media services for receiving media content according to the user profiles, which can include without limitation operational aspects for configuring access to media content. In particular, the user profiles can include configuration settings for receiving and managing media content, including services, such as messaging, music, photos, Internet, movies, television, and any features delivered to the STB 106 that are available to devices within the property 102.

FIG. 7 presents an exemplary illustration of a GUI 700 for configuring a user profile with messaging services. Notably, the user is but one of a plurality of users whose user profile can be configured and managed by an administrator who provisions users to receive messaging services at the property 102. As shown in FIG. 7, the GUI 700 can include user account settings for configuring a delivery of media services. User account settings can include a name of a messaging server, a user email address, a user name, and a password associated with an existing or new account. Notably, the user may already have pre-existing messaging services, and the configuration settings of the user profile can effectively direct the messaging services to the STB 106.

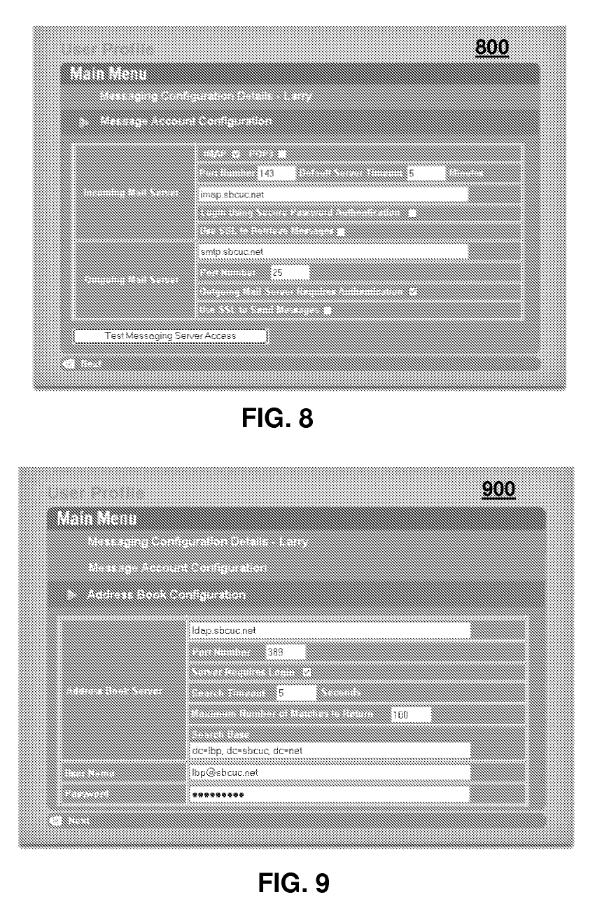

FIG. 8 presents an exemplary illustration of a GUI 800 for configuring the messaging services. As an example, the configuration settings can identify a type of messaging server (e.g., IMAP, POP3, etc.), an addresses for incoming and outgoing mail servers, a port number, or other suitable messaging service parameters. Configuration utilities for managing addresses, contacts, and other information are also available to the administrator when provisioning the user accounts. For example, as shown in FIG. 9, the administrator can configure an address book presented by GUI 900 to allow the user to access media content related to an already existing list of contacts. As another example, user profiles can be configured to import email files, contact lists, website links, download histories, images, favorite lists, and so on.

Upon configuring the one or more user accounts for provisioning the one or more users with user profiles to access media content, the STB 106 can test user access to the media content as shown in step 218. For example, as shown in FIG. 7, the GUI 700 can provide a test button to evaluate an operability of the connection from the STB 106 to the corresponding service provider's communication system. This allows the administrator to verify that the configuration settings of the user profile are correct and ensures that the provisioned user can properly access the media content when logged in to the STB 106.

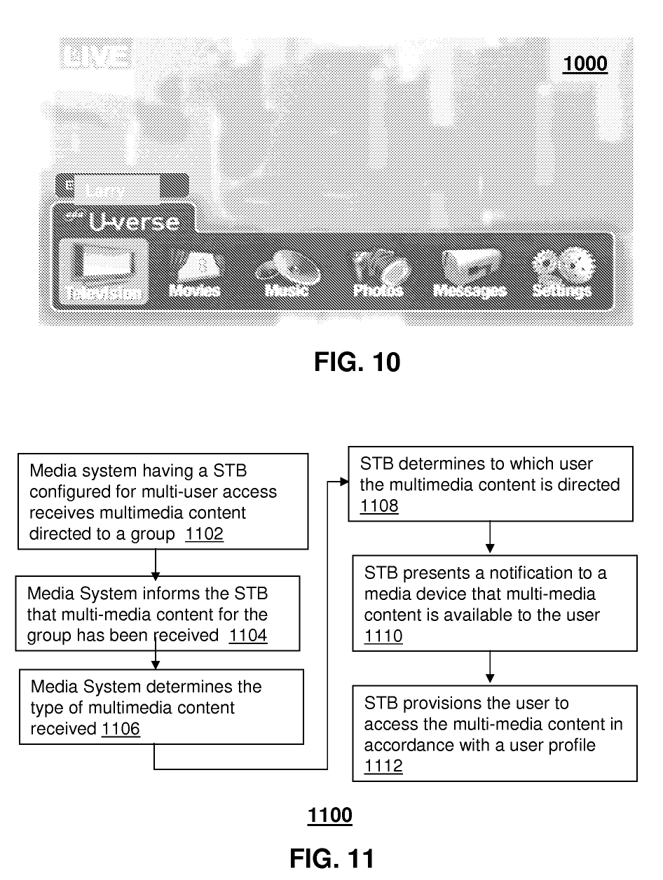

If at step 220 access to the media content is granted, the STB 106 can present an indication of the accounts provisioned. As one example, referring additionally to FIG. 10, the STB 106 can present an exemplary screen 1000 assigned to the user whose user profile was just configured. The GUI can present this screen to inform the administrator that the user profile was successfully configured. The user screen can correspond to the screen that the user will see when logged in to the STB 106. If at step 220 access is not granted, the STB 106 can prompt the administrator to re-enter configuration settings to re-evaluate the network connectivity.

At step 222, the STB can present a limited user set-up sequence, which corresponds to the log-in screen the user will encounter when logging in to the STB 106. In one aspect, the limited user set-up can start after the STB 106 presents the user screen 1000 of FIG. 10. In one embodiment, the limited user set-up sequence allows the administrator to test the user profile as though the administrator were the user. As part of the limit user set-up, the STB 106 can request a security code such as a personal identification number or PIN that is validated. Alternatively, PINs can be made optional by the administrator for secondary members. In this embodiment, a limited user can share his/her accounts with other limited users, and is not burdened with a security login process. However, for a primary member a PIN can be established at all times to avoid reconfiguration of limited user accounts without authorization by the administrator.

Once the administrator and limited users have together fully configured the user profiles of each user sharing the STB 106, operations for each limited user's account can be enabled in step 224. From this point on, each user can access media content from the STB 106 as defined by the combination of the configuration settings defined by the administrator and the user preferences established by the limited user. The STB 106 can monitor for an update to the user profile of each user which may be desired by the administrator or the limited user at a later time. If such a request is detected, the administrator or limited user can be directed to step 208, if it is the administrator requesting, or step 218 if it is the limited user requesting an update. The present disclosure contemplates the number of features that can be provisioned by the administrator and/or limited user being as extensive as the number of media features made available by a service provider of the media content.

FIG. 11 depicts an exemplary method 1100 operating in portions of the communication system 100. More specifically, the method 1100 describes how the STB 106 can manage delivery of media content to users in a multi-user environment. The method 1100 can start in a state wherein multiple user accounts (i.e., user profiles) have already been configured by an administrator, for example, in accordance with the method 200 (See FIGS. 2 and 3).

The method 1100 can start at step 1102, in which a media system having a STB 106 configured for multi-user access receives multimedia content directed to a group. The media system can comprise any of the network elements shown in the communication system of FIG. 1 (e.g., IPTV Services, Satellite Services, Broadband Services, etc.). The multimedia content can be email, voice, or data, delivered to the STB 106 by way of IPTV services, satellite services, broadband services, or telecommunication services as discussed in FIG. 1. The group can comprise users having user profiles configured for accessing media content through the STB 106. As an example, the group can be identified by a group phone number (e.g., phone number of the property 102), or a group email address (e.g., Xfamily@bellsouth.net).

At step 1104, the media system informs the STB 106 that multimedia content for the group has been received. As one example, upon the broadband services 132 receiving an email directed to the group, the broadband services 132 can send a message to the STB 106 to indicate that a message for the group has been received, and is available. As another example, the telecommunication system 117 can send a message to the STB 106 to indicate that a voice mail for the group has been received, and is available.

At step 1106, the STB 106 can determine the type of multimedia content received. For example, the STB 106 can distinguish between a voice mail that was left on a communication device 116 (e.g., VoIP phone) in the property 102, and an email message that was sent to a communication device (e.g., laptop). At step 1108, the STB 106 can determine to which user the multimedia content is directed. For example, the STB 106 can identify the intended email recipient from a descriptor in the group email, or the intended email recipient from a name in a voice mail message, in view of the user profiles.

Upon identifying to whom the multimedia content is directed, the STB 106 at step 1110 can inform the STB 106 that multimedia content for a user has been received. In one arrangement, the STB 106 can determine if the user is already logged in to the STB 106, and if so, inform the user directly by way of a message screen. If the user is logged in, the STB 106 at step 1112 can provision the user to access the multi-media content in accordance with the user's profile. Recall, the user profile can establish permission for the multimedia content, and can direct the STB 106 to perform automated tasks in view of the multimedia content. As one example, the STB 106 can automatically filter email messages, or text messages, for content based on administrator assigned configuration settings.

If the user is not immediately available, the STB 106 by way of the telecommunication services 117 can send a voice mail or text message to a communication device 116 operated by the user. In yet another arrangement, the STB 106 can wait for the user to log in to the STB 106, either directly or remotely, and then inform the user that multimedia content received is available.

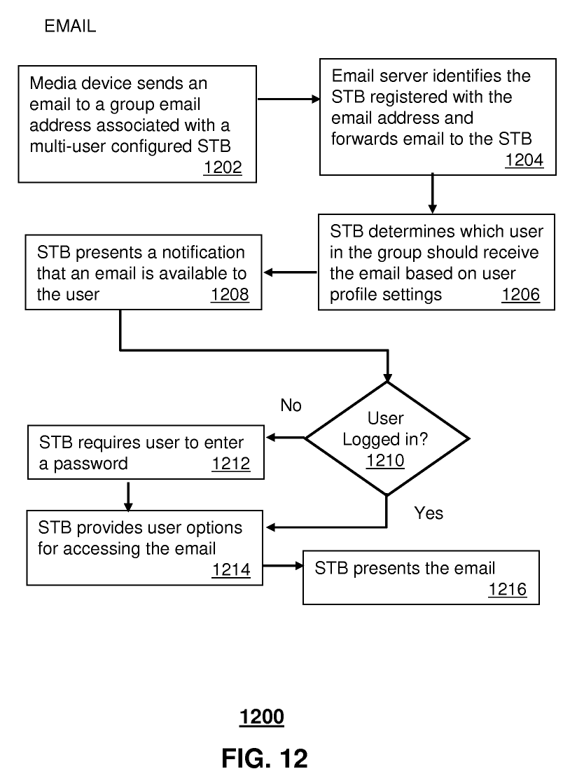

FIG. 12 depicts an exemplary flowchart 1200 for receiving email notifications that was briefly presented in method 1100 of FIG. 11 and can be utilized in combination therewith. It should be noted that the flowchart 1200 can be practiced with more or less than the number of steps shown. The flowchart can start at step 1202 in which a media device sends an email to a group email address associated with a multi-user configured STB. For example, a mobile user operating a communication device 116 within the telecommunication system 117 can send an email to a group email address of the STB 106. The email message can be received by an email server managed by the broadband services 132. At step 1204, the email server can identify the particular STB associated with the email address, and can forward the email to the STB 106. For example, the email server can look up subscription information that identifies the residence corresponding to the email address, and can send the email to the STB 106.

At step 1206, the STB 106 can determine which user in the group should receive the email based on user profile settings. For example, the STB 106 can identify a name in the email and determine which user profiles use the name in an email address. Other techniques for identifying the email recipient are herein contemplated. At step 1208, the STB 106 can present a notification that an email is available to the user. For example, the STB 106 can present an audible or visual notification to the user by way of a display message on a media device 108, or by way of a communication device 116 (e.g., text message).

If the STB 106 at step 1210 determines the user is already logged in to the STB 106, the STB can provide the user options for accessing the multimedia content at step 1214. For example, the user can present an email dialogue screen for accessing the email. If the user is not logged in, the STB 106 can require the user to enter a password to log in and retrieve the email as shown at step 1212. Alternatively, the STB 106 can request the user to enter a password, such as a PIN, to bypass the log-in process, and just retrieve the email. Upon the STB 106 presenting the user with options for retrieving the email, the STB 106 can present the email to the user at step 1216.

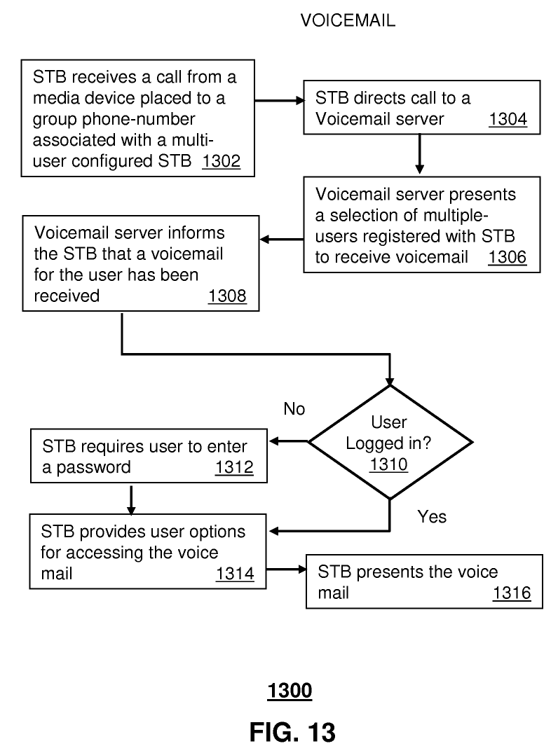

FIG. 13 depicts an exemplary flowchart 1300 for receiving voice mail notifications that was briefly presented in method 1100 of FIG. 11 and can be utilized in combination therewith. It should be noted that the flowchart 1300 can be practiced with more or less than the number of steps shown. The flowchart can start at step 1302 in which a caller of a media device places a call to a group phone-number associated with the multi-user configured STB 106. As an example, the group phone number can be a single phone number associated with the property 102. If none of the users at the property 102 accepts the call or if the call is not directly received at the property 102, the STB 106 can direct the call to a voice mail server, as shown in step 1304. It should be noted that the voice mail server can be local to the property 102 (e.g., on premise) or managed by a service provider remote from the property (e.g., off premise). In another arrangement, the STB 106 can provide voice mail services. The voice mail server can then proceed to present a selection of multiple-users registered with the STB to receive voicemail, as shown in step 1306. As one example, the voice mail server can include an Interactive Voice Response (IVR) system that audibly presents to the caller a menu dialogue identifying the users by name. The caller can select one of the users from the menu, and leave a voice mail message for the selected user. Upon processing the voice mail message, the voice mail server at step 1308 can inform the STB 106 that a voicemail for the user has been received. As an example, the STB 106 can present an audible or visual notification to the user by way of a display message on a media device 108, or by way of a communication device 116 (e.g., text message).

If the STB 106 at step 1310 determines the user is already logged in to the STB 106, the STB can provide the user options for accessing the voice mail as shown in step 1314. For example, the user can present a voice mail dialogue screen for accessing the voice mail. If the user is not logged in, the STB 106 can require the user to enter a password to log in and retrieve the voice mail as shown in step 1312. Alternatively, the STB 106 can request the user to enter a password, such as a PIN, to bypass the log-in process, and just retrieve the voice mail. Upon the STB 106 presenting the user with options for retrieving the voice mail, the STB 106 can present the voice mail to the user at step 1316.

Upon reviewing the aforementioned embodiments, it would be evident to an artisan with ordinary skill in the art that said embodiments can be modified, reduced, or enhanced without departing from the scope and spirit of the claims described below. There are numerous configurations for other media services that can be conceived for provisioning a delivery of media content in a multi-user environment that can be applied to the present disclosure without departing from the scope of the claims defined below. For example, the STB can be configured for Internet messaging services, VoIP messaging services, instant messaging services, blog services, and file sharing services. Additionally, any present or media service feature not described herein can be applied in whole or in part to method 200 and 1100-1300. The access settings can be communicated to new STBs as the media configuration of the property 102 changes without the need to separately program the STB. These are but a few examples of modifications that can be applied to the present disclosure without departing from the scope of the claims stated below. Accordingly, the reader is directed to the claims section for a fuller understanding of the breadth and scope of the present disclosure.

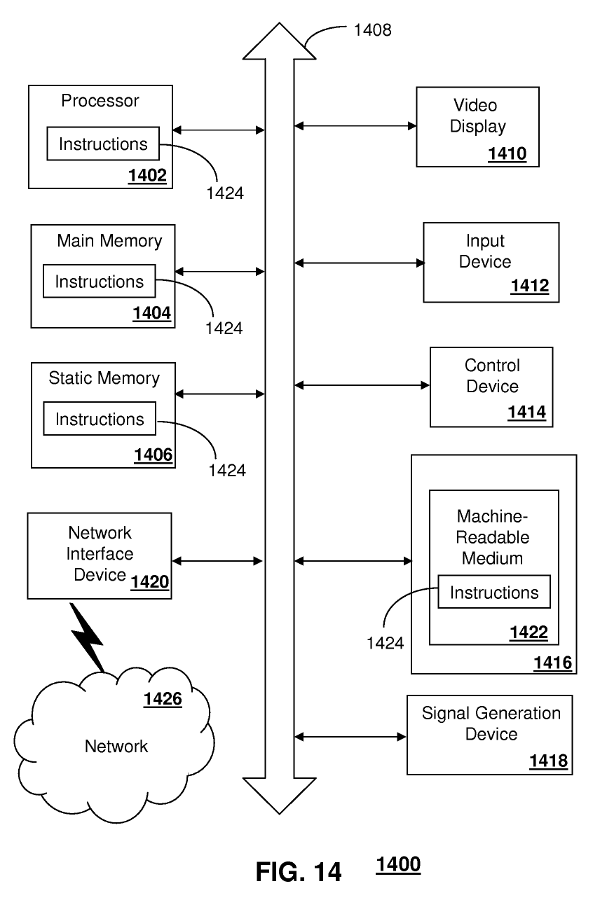

FIG. 14 depicts an exemplary diagrammatic representation of a machine in the form of a computer system 1400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1400 may include a processor 1402 (e.g., a central processing unit (CPU), a graphics processing unit (GPU, or both), a main memory 1404 and a static memory 1406, which communicate with each other via a bus 1408. The computer system 1400 may further include a video display unit 1410 (e.g., a liquid crystal display (LCD), a flat panel, a solid state display, or a cathode ray tube (CRT)). The computer system 1400 may include an input device 1412 (e.g., a keyboard), a cursor control device 1414 (e.g., a mouse), a mass storage medium 1416, a signal generation device 1418 (e.g., a speaker or remote control) and a network interface device 1420.

The mass storage medium 1416 may include a computer-readable storage medium 1422 on which is stored one or more sets of instructions (e.g., software 1424) embodying any one or more of the methodologies or functions described herein, including those methods illustrated above. The computer-readable storage medium 1422 can be an electromechanical medium such as a common disk drive, or a mass storage medium with no moving parts such as Flash or like non-volatile memories. The instructions 1424 may also reside, completely or at least partially, within the main memory 1404, the static memory 1406, and/or within the processor 1402 during execution thereof by the computer system 1400. The main memory 1404 and the processor 1402 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 1424, or that which receives and executes instructions 1424 from a propagated signal so that a device connected to a network environment 1426 can send or receive voice, video or data, and to communicate over the network 1426 using the instructions 1424. The instructions 1424 may further be transmitted or received over a network 1426 via the network interface device 1420.

While the computer-readable storage medium 1422 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a Set-Top Box (STB), comprising computer instructions for:
receiving multimedia content from one or more broadband providers;
configuring individual access to the multimedia content among a group of users based on access settings of individual user accounts, wherein each of the individual user accounts has a separate service package provided by the one or more broadband providers, and wherein the access settings are managed by a primary member of the group; and
provisioning the multimedia content in accordance with the access settings.

2. The storage medium of claim 1, wherein the individual user accounts are separately billed.

3. The storage medium of claim 1, wherein the primary member configures the individual user accounts with rights and permissions for accessing the multimedia content.

4. The storage medium of claim 1, wherein the access settings are parental controls that individually limit a user's access to the multimedia content.

5. The storage medium of claim 1, wherein the multimedia content includes at least one among Internet, email, voicemail, television, movies, music, photos, and messages.

6. The storage medium of claim 1, wherein the one or more broadband providers provide at least one among satellite services, cable services, DSL services, and dial-up services.

7. The storage medium of claim 1, further comprising computer instructions for delivery of the multimedia content to one or more media devices comprising at least one among a television unit, a computer, a laptop, and a mobile device.

8. The storage medium of claim 1, further comprising computer instructions for communicating the access settings to another STB.

9. A Set-Top Box (STB), comprising a controller element to:
receive multimedia content from a communication system;
configure individual access to the multimedia content among a group of users in accordance with individual user profiles, wherein each of the individual user profiles has a separate service package provided by one or more broadband providers; and
provision a delivery of the multimedia content to a media device in accordance with access settings defined at least in part in the individual user profiles.

10. The STB of claim 9, wherein the individual user profiles are managed by a primary member of the group.

11. The STB of claim 9, wherein the group of users are separately billed for each separate service package.

12. The STB of claim 9, wherein the access settings grant rights or permissions comprising at least one among viewing, downloading, or sharing the multimedia content.

13. The STB of claim 9, wherein the access settings restrict or limit access to at least one among Internet, email, voice mail, television, movies, music, photos, and messages.

14. The STB of claim 9, wherein the media device is at least one among a television unit, a computer, a laptop, and a mobile device.

15. The STB of claim 9, wherein the controller element transmits account modification information to the primary member via at least one among an email message, a text message, and a voice mail.

16. The STB of claim 9, wherein the controller element receives configuration changes from the primary member over a remote connection, and modifies an individual user account in accordance with the configuration changes.

17. The STB of claim 9, wherein the controller element receives a message, directs the message to an individual user account of the group of users, and provides notice of the message to a user of the individual user account.

18. The STB of claim 17, wherein the controller element authenticates a user of the group of users with a personal identification number (PIN) to access the message.

19. The STB of claim 17, wherein the message is at least one among an email message, a voice mail message, and a text message that is displayed on the media device.

20. The STB of claim 9, wherein the multimedia content comprises broadcast and interactive media services of an Internet Protocol Television (IPTV).

21. The STB of claim 9, wherein the controller element sends user account information to another STB that delivers other multimedia content and manages access to the other multimedia content based at least in part on the user account information.

22. A media device, comprising a controller element to receive media content from a Set-Top Box (STB), wherein access to the media content is provisioned for individual users in accordance with individual user account profiles managed by a primary member, and wherein the individual user account profiles have separate service packages provided by one or more broadband providers.

23. The media device of claim 22, wherein the media device includes at least one among a television, a multimedia system, and a computing device.

24. The media device of claim 22, wherein the individual user account profiles limit individual user access to at least one among Internet, email, voice mail, television, movies, music, photos, and messages.

25. A method, comprising provisioning a distribution of media content to a plurality of users sharing a set-top-box (STB) in accordance with access settings in user profiles managed by a primary member, wherein the user profiles have a separate service package provided by one or more broadband providers.

26. The method of claim 25, comprising directing an email message or a voice mail message to a user of the STB, and notifying the user that the email message or voice mail message is available at the STB.

27. The method of claim 25, wherein the plurality of users are separately billed for each separate service package.
